(19) United States
(12) Patent Application Publication
(10) Pub. No.: US 2026/0238780 A1
(43) Pub. Date: Aug. 13, 2026

(54) Purpose And Various Constraints For Neural-Network Post-Processing Filter Group

(71) Applicant: Bytedance Inc., Los Angeles, CA (US)

(72) Inventors: Wei Jia, San Diego, CA (US); Ye-Kui Wang, San Diego, CA (US); Kai Zhang, San Diego, CA (US); Li Zhang, San Diego, CA (US)

(21) Appl. No.: 19/637,899

(22) Filed: Apr. 2, 2026

Related U.S. Application Data
(63) Continuation of application No. PCT/US2024/050032, filed on Oct. 4, 2024.
(60) Provisional application No. 63/588,153, filed on Oct. 5, 2023.

(51) Int. Cl. H04N 19/117; H04N 19/30; H04N 19/70

(52) U.S. Cl. CPC H04N 19/117; H04N 19/30; H04N 19/70

(57) ABSTRACT

A mechanism for processing video data is disclosed. The mechanism includes determining multiple neural-network post-processing filters (NNPFs) or neural-network post-processing filter groups (NNPFGs) defined in one or more supplemental enhancement information (SEI) messages share a same NNPF purpose. A conversion is performed between visual media data and a bitstream based on the determining.

### CROSS-REFERENCE TO RELATED APPLICATIONS

This is a continuation of International Patent Application No. PCT/US2024/050032, filed on Oct. 4, 2024, which claims the priority to and benefits of U.S. Provisional Patent Application No. 63/588,153, filed on Oct. 5, 2023. All the aforementioned patent applications are hereby incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining multiple neural-network post-processing filters (NNPF) or neural-network post-processing filter group (NNPFG) defined in one or more supplemental enhancement information (SEI) messages share the same NNPF purpose; and performing a conversion between a visual media data and a bitstream based on the NNPF purpose.

A second aspect relates to an apparatus for processing video data comprising: a processor; and a non-transitory memory with instructions thereon, wherein the instructions upon execution by the processor, cause the processor to perform any of the preceding aspects.

A third aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises: determining multiple neural-network post-processing filters (NNPF) or neural-network post-processing filter group (NNPFG) defined in one or more supplemental enhancement information (SEI) messages share the same NNPF purpose; and generating a bitstream based on the determining.

A fifth aspect relates to a method for storing bitstream of a video comprising determining multiple neural-network post-processing filters (NNPF) or neural-network post-processing filter group (NNPFG) defined in one or more supplemental enhancement information (SEI) messages share the same NNPF purpose; generating a bitstream based on the determining; and storing the bitstream in a non-transitory computer-readable recording medium.

A sixth aspect relates to a method, apparatus, or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram showing an example video processing system.

FIG. 2 is a block diagram of an example video processing apparatus.

FIG. 3 is a flowchart for an example method of video processing.

FIG. 4 is a block diagram that illustrates an example video coding system.

FIG. 5 is a block diagram that illustrates an example encoder.

FIG. 6 is a block diagram that illustrates an example decoder.

FIG. 7 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and embodiments illustrated below, including the exemplary designs and implementations illustrated and described herein, but may be modified within the scope of the appended claims along with their full scope of equivalents.

Section headings are used in the present disclosure for ease of understanding and do not limit the applicability of techniques and embodiments disclosed in each section only to that section. Furthermore, H.266 terminology is used in some description only for ease of understanding and not for limiting scope of the disclosed embodiments. As such, the embodiments described herein are applicable to other video codec protocols and designs also. In the present disclosure, editing changes are shown to text by bold italics indicating cancelled text and bold indicating added text, with respect to the Versatile Video Coding (VVC) specification.

### 1. Initial Discussion

This disclosure is related to image/video coding technologies. Specifically, this disclosure is related to the purpose and various constraints for neural-network post-processing filters (NNPF). The ideas may be applied individually or in various combinations, for video bitstreams coded by any codec, e.g., the versatile video coding (VVC) standard and/or the versatile supplemental enhancement information (SEI) messages for coded video bitstreams (VSEI) standard.

### 2. Abbreviations

The present disclosure includes the following abbreviations. Adaptation parameter set (APS), access unit (AU), coded layer video sequence (CLVS), coded layer video sequence start (CLVSS), cyclic redundancy check (CRC), coded video sequence (CVS), finite impulse response (FIR), intra random access point (IRAP), network abstraction layer (NAL), picture parameter set (PPS), prediction unit (PU), random access skipped leading (RASL) picture, supplemental enhancement information (SEI), step-wise temporal sublayer access (STSA), video coding layer (VCL), versatile supplemental enhancement information as described in Rec. ITU-T H.274|ISO/IEC 23002-7 (VSEI), video usability information (VUI), versatile video coding as described in Rec. ITU-T H.266|ISO/IEC 23090-3 (VVC).

### 3. Further Discussion

### 3.1 Video Coding Standards

Video coding standards have evolved primarily through the development of International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video and H.264/MPEG-4 Advanced Video Coding (AVC) and H.265/high efficiency video coding (HEVC) [1] standards. Since H.262, the video coding standards are based on the hybrid video coding structure wherein temporal prediction plus transform coding are utilized. To explore video coding technologies beyond high efficiency video coding (HEVC), the Joint Video Exploration Team (JVET) was founded by video coding experts group (VCEG) and motion picture experts group (MPEG). Further, methods have been adopted by JVET and put into the reference software named Joint Exploration Model (JEM) [2]. The JVET was later renamed to be the Joint Video Experts Team (JVET) when the Versatile Video Coding (VVC) project officially started. VVC [3] is a coding standard targeting a 50% bitrate reduction as compared to HEVC.

The Versatile Video Coding (VVC) standard (ITU-T H.266|ISO/IEC 23090-3) [3] and the associated Versatile Supplemental Enhancement Information for coded video bitstreams (VSEI) standard (ITU-T H.274|ISO/IEC 23002-7) [4] are designed for use in a maximally broad range of applications, including both the simple uses such as television broadcast, video conferencing, or playback from storage media, and also more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard under development by MPEG.

### 3.2 SEI Messages in General and in VVC and VSEI

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D of VVC specifies syntax and semantics for SEI message payloads for some SEI messages, and specifies the use of the SEI messages and VUI parameters for which the syntax and semantics are specified in ITU-T H.274|ISO/IEC 23002-7.

### 3.3 Signalling of Neural-Network Post Filters

JVET-AE2006 [5] includes the specification of two SEI messages for signalling of neural-network post-filters, namely the neural-network post-filter characteristics (NNPFC) SEI message and the neural-network post-filter activation (NNPFA) SEI. JVET-AE2005 [6] includes the specification of the use of the NNPFC SEI message in VVC bitstreams.

### 3.4 Technologies Under Consideration for Signalling of Neural-Network Post-Filters

JVET-AE2032 [7] contains draft text to modify the neural-network post-filter SEI messages and draft text to specify the encoder optimization SEI message, source picture timing SEI message, object mask information SEI message, and neural-network post-filter group SEI message. The specification of NNPFC and NNPFA SEI message changes in JVET-AE2032 are as follows.

Changes to the specification text:

Changes to subclause 8.28

Modify subclause 8.28 per JVET-AE0061 and JVET-AE0298 to be as follows

8.28 Neural-network post-filter SEI messages
8.28.1 General post-processing filtering process using NNPFs

### 8.28.1.1 General

Input to this process is a bitstream BitstreamToFilter. Output of this process is a list of NNPF output pictures ListNnpfOutputPics.

First, BitstreamToFilter is decoded, and the list CroppedDecodedPictures is set to be the list of the cropped decoded pictures in output order resulted from decoding BitstreamToFilter.

Second, NnpfCand is set to contain any single NNPF or any single NNPF group. When NnpfCand contains an NNPF group with nnpfgc_grouping_type equal to 3, the subsequent specifications of this subclause apply when NnpfCand is set to contain individually each member NNPF, if any, and each member NNPF group, if any, of the NNPF group with nnpfgc_grouping_type equal to 3.

Third, the filtering process for one picture, as specified in subclause 8.28.1.2, is repeatedly invoked, in output order, for each cropped decoded picture that is in CroppedDecodedPictures and for which the single NNPF contained in NnpfCand or the single NNPF group contained in NnpfCand, or one or more NNPFs or NNPF groups defined as alternatives or alternating in the NNPF group contained in NnpfCand are activated.

The order of the pictures in ListNnpfOutputPics is in output order.

Within ListNnpfOutputPics there shall be no more than one picture pertaining to any particular output time instance. When for any particular picture in CroppedDecodedPictures there are multiple NNPFs activated and only one of the NNPFs is allowed to be chosen to be applied although any of the NNPFs may be chosen, the above constraint shall apply regardless of which NNPF is chosen to be applied to the particular picture.

BitstreamToFilter may be processed multiple times to generate multiple different ListNnpfOutputPics through the second and third steps above.

### 8.28.1.2 Filtering Process for One Picture

The filtering process specified in this subclause applies to each cropped decoded picture, referred to as the current picture, that is in CroppedDecodedPictures and for which one or more NNPFs or NNPF groups in NnpfCand are activated.

An NNPF or an NNPF group to be applied to the current picture is selected as follows:
If NnpfCand contains a single NNPF and that NNPF is activated for the current picture according to an NNPFA SEI message, that NNPF is selected to be applied to the current picture.
Otherwise, if NnpfCand contains an NNPF group with nnpfgc_grouping_type equal to 2 and any NNPF of the NNPF group is activated for the current picture according to NNPFA SEI message, that NNPF is selected to be applied to the current picture.
Otherwise, if NnpfCand contains an NNPF group with nnpfgc_grouping_type equal to 0 and that NNPF group is activated for the current picture according to an NNPFGA SEI message, that NNPF group is selected to be applied to the current picture.
Otherwise (NnpfCand contains an NNPF group with nnpfgc_grouping_type equal to 1), the following applies:
   A set of candidate NNPFs or NNPF groups candSet is initially empty and then set to contain the following:
      The NNPFs that are activated for the current picture according to NNPFA SEI messages and are included in the NNPF group contained in NnpfCand.
      The NNPF groups that are activated for the current picture according to NNPFGA SEI messages and are included in the NNPF group contained in NnpfCand.
   For each candidate NNPF or NNPF group candFilter in candSet, the following applies:
      When one or more of the input pictures of candFilter are input pictures to the NNPF or NNPF group prevFilter that was used in any previous invocation of the filtering process specified in this subclause for the same NnpfCand, candFilter is excluded from candSet.
   Any NNPF or NNPF group remaining in candSet is selected to be applied to the current picture.

When applying an NNPF to the current picture, the following applies:
The filtered and/or interpolated pictures are generated by the NNPF by applying the NNPF process specified in the semantics of the NNPFC SEI message, in a patch-wise manner, to the current picture.
The order of the pictures generated by the NNPF by applying the NNPF process being stored into the output tensor of the NNPF is in output order.
The pictures generated by the NNPF and output by the NNPF process are included into ListNnpfOutputPics, in the same order as when the pictures are stored into the output tensor of the NNPF.

When applying an NNPF group to the current picture, the following applies:
The filtered and/or interpolated pictures are generated by applying the NNPF process specified in the semantics of the NNPFC SEI message, in a patch-wise manner, as specified in the semantics of the NNPFGA SEI message activating the NNPF group.
The pictures in NnpfgaOutputPicList are included into ListNnpfOutputPics, in the same order as the pictures are stored in NnpfgaOutputPicList.

### 8.28.2 Neural-Network Post-Filter Characteristics SEI Message

### 8.28.2.1 Neural-Network Post-Filter Characteristics SEI Message Syntax

| | Descriptor |
|---|---|
| nn_post_filter_characteristics( payloadSize ) { | |
| ... | u(1) |
| if( nnpfc_complexity_info_present_flag ) { | |
| nnpfc_parameter_type_idc | u(2) |
| if( nnpfc_parameter_type_idc != 2 ) | |
| nnpfc_log2_parameter_bit_length_minus3 | u(2) |
| nnpfc_num_parameters_idc | u(6) |
| nnpfc_num_kmac_operations_idc | ue(v) |
| nnpfc_total_kilobyte_size | ue(v) |
| } | |
| nnpfc_metadata_extension_num_bits | ue(v) |
| if( nnpfc_metadata_extension_num_bits > 0 ) { | |
| if( nnpfc_purpose = = 0 ) { | |
| nnpfc_application_purpose_tag_uri_present_flag | u(1) |
| if( nnpfc_application_purpose_tag_uri_present_flag) | |
| nnpfc_application_purpose_tag_uri | st(v) |
| } | |
| nnpfc_reserved_metadata_extension /*Remaining bits of the metadata extension*/ | u(v) |
| } | |
| } | |
| ... | |
| } | |

### 8.28.2.2 Neural-Network Post-Filter Characteristics SEI Message Semantics

nnpfc_purpose indicates the purpose of the NNPF as specified in Table 20, where (nnpfc_purpose & bitMask) not equal to 0 indicates that the NNPF has the purpose associated with the bitMask value in Table 20. When nnpfc_purpose is greater than 0 and (nnpfc_purpose & bitMask) is equal to 0, the purpose associated with the bitMask value is not applicable to the NNPF. When nnpfc_pupose is equal to 0, the NNPF may be used as determined by the application and as specified by the nnpfc_application_purpose_tag_uri.

The value of nnpfc_purpose shall be in the range of 0 to 63, inclusive, in bitstreams conforming to this edition of this document. Values of 64 to 65 535, inclusive, for nnpfc_purpose are reserved for future use by ITU-T|ISO/IEC and shall not be present in bitstreams conforming to this edition of this document. Decoders conforming to this edition of this document shall ignore NNPFC SEI messages with nnpfc_purpose in the range of 64 to 65 535, inclusive.

TABLE 20
Definition of nnpfc_purpose

| bitMask | Interpretation |
|---|---|
| 0x01 | General visual quality improvement |
| 0x02 | Chroma upsampling (from the 4:2:0 chroma format to the 4:2:2 |
| | or 4:4:4 chroma format, or from the 4:2:2 chroma format to the |
| | 4:4:4 chroma format) |
| 0x04 | Resolution resampling (increasing or decreasing the |
| | width or height) |
| 0x08 | Picture rate upsampling |
| 0x10 | Bit depth upsampling (increasing the luma bit depth or the |
| | chroma bit depth) |
| 0x20 | Colourization |

The variables chromaUpsamplingFlag, resolutionResamplingFlag, pictureRateUpsamplingFlag, bitDepthUpsamplingFlag, and colourizationFlag, specifying whether nnpfc_purpose indicates the purpose of the NNPF to include chroma upsampling, resolution resampling, picture rate upsampling, bit depth upsampling, and colourization, respectively, are derived as follows:

$$chromaUpsamplingFlag = ( ( nnpfc\_purpose \& 0 \times 02 ) > 0 ) ? 1 : 0$$

$$resolutionResamplingFlag = ( ( nnpfc\_purpose \& 0 \times 04 ) > 0 ) ? 1 : 0$$

$$pictureRateUpsamplingFlag = ( ( nnpfc\_purpose \& 0 \times 08 ) > 0 ) ? 1 : 0$$

$$bitDepthUpsamplingFlag = ( ( nnpfc\_purpose \& 0 \times 10 ) > 0 ) ? 1 : 0$$

$$colourizationFlag = ( ( nnpfc\_purpose \& 0 \times 20 ) > 0 ) ?$$

NOTE 2—When a reserved value of nnpfc_purpose is taken into use in the future by ITU-T|ISO/IEC, the syntax of this SEI message could be extended with syntax elements whose presence is conditioned by nnpfc_purpose being equal to that value.

When ChromaFormatIdc is equal to 3, chromaUpsamplingFlag shall be equal to 0.

When ChromaFormatIdc or chromaUpsamplingFlag is not equal to 0, colourizationFlag shall be equal to 0.

When pictureRateUpsamplingFlag is equal to 1 and the input picture with index 0 is associated with a frame packing arrangement SEI message with fp_arrangement_type equal to 5, all input pictures are associated with a frame packing arrangement SEI message with fp_arrangement_type equal to 5 and the same value of fp_current_frame_is_frame0_flag.

nnpfc_application_purpose_tag_uri_present_flag equal to 1 indicates that the is present in this NNPFC SEI message. nnpfc_application_purpose_tag_uri syntax element nnpfc_application_purpose_tag_uri_present_flag equal to 0 indicates that the nnpfc_application_purpose_tag_uri syntax element in this NNPFC SEI is not present message. When not present nnpfc_application_purpose_tag_uri_present_flag is inferred to be equal to 0.

nnpfc_application_purpose_tag_uri specifies a tag URI with syntax and semantics as specified in IETF RFC 4151 identifying the application determined purpose of the NNPF, when nnpfc_purpose is equal to 0.

NOTE 4—nnpfc_application_purpose_tag_uri enables uniquely identifying the application determined purpose of NNPF without needing a central registration authority.

nnpfc_metadata_extension_num_bits equal to 0 specifies that nnpfc_reserved_metadata_extension is not present. nnpfc_metadata_extension_num_bits greater than 0 specifies the length, in bits, of nnpfc_reserved_metadata_extension. nnpfc_metadata_extension_num_bits shall be in the range of 0 to 2048 in this edition of this document when nnpfc_purpose is not equal to 0 and in the range of 1 to 2048 when nnpfc_purpose is equal to 0. Values in the range of 2049 to 4096, inclusive, for nnpfc_metadata_extension_num_bits are reserved for future use by ITU-T|ISO/IEC and shall not be present in bitstreams conforming to this edition of this document. Decoders conforming to this edition of this document shall allow any value of nnpfc_metadata_extension_num_bits in the range of 0 to 4096, inclusive. Values of nnpfc_metadata_extension_num_bits greater than 4096 shall not be present in bitstreams conforming to this edition of this document and are not reserved for future use.

nnpfc_reserved_metadata_extension shall not be present in bitstreams conforming to this edition of this document. However, decoders conforming to this edition of this document shall ignore the presence and value of nnpfc_reserved_metadata_extension. When present, and when nnpfc_purpose is equal to 0 and nnpfc_application_purpose_tag_uri_present_flag is equal to 1 the length, in bits, of nnpfc_reserved_metadata_extension is equal to nnpfc_metadata_extension_num_bits-Length of (nnpfc_application_purpose_tag_uri)−1. When present and when nnpfc_purpose is equal to 0 and nnpfc_application_purpose_tag_uri_present_flag is equal to 0 the length, in bits, of nnpfc_reserved_metadata_extension is equal to nnpfc_metadata_extension_num-1 bits. When present and when nnpfc_purpose is not equal to 0 the length, in bits, of nnpfc_reserved_metadata_extension is equal to nnpfc_metadata_extension_num_bits.

### 8.28.3 Neural-Network Post-Filter Activation SEI Message

### 8.28.3.1 Neural-Network Post-Filter Activation SEI Message Syntax

No change.

### 8.28.3.1 Neural-Network Post-Filter Activation SEI Message Syntax

The neural-network post-filter activation (NNPFA) SEI message activates or de-activates the possible use of the target neural-network post-processing filter (NNPF) or the target neural-network post-processing filter group (NNPFG), identified by nnpfa_target_id and nnpfa_target_base_flag, for post-processing filtering of a set of pictures.

For a particular picture for which the NNPF is activated, the target NNPF is derived as follows:
If nnpfa_target_base_flag is equal to 1, the target NNPF is the base NNPF with nnpfc_id equal to nnpfa_target_id.
Otherwise (nnpfa_target_base_flag is equal to 0), the target NNPF is the NNPF specified by the last NNPFC SEI message with nnpfc_id equal to nnpfa_target_id that precedes the first VCL NAL unit of the current picture in decoding order and is not a repetition of the NNPFC SEI message that contains the base NNPF.

NOTE 1—There can be several NNPFA SEI messages present for the same picture, for example, when the NNPFs are meant for different purposes or for filtering of different colour components.

For a particular picture for which the NNPFG is activated, the target NNPFG is the NNPFG specified by the NNPFG SEI message with nnpfg_id equal to nnpfa_target_id that precedes the first VCL NAL unit of the current picture in decoding order.

nnpfa_target_id indicates the target NNPF or NNPFG, which is specified by one or more NNPFC SEI messages or an NNPFG SEI message that pertain to the current picture and have nnpfc_id or nnpfg_id equal to nnpfa_target_id. The value of nnpfa_target_id shall be in the range of 0 to 232-2, inclusive.

Add subclauses 8.28.4 and 8.28.5 as follows:

### 8.28.4 Neural-Network Post-Filter Group Characteristics SEI Message

### 8.28.4.1 Neural-Network Post-Filter Group Characteristics SEI Message Syntax

| | Descriptor |
|---|---|
| nn_post_filter_group_characteristics( payloadSize ) { | |
| nnpfgc_id | ue(v) |
| nnpfgc_grouping_type | ue(v) |
| if( nnpfgc_grouping_type = = 0 \|\| | |
| nnpfgc_grouping_type = = 2 ) | |
| nnpfgc_purpose | u(16) |
| nnpfgc_num_members_minus2 | ue(v) |
| for( i = 0; i <= nnpfgc_num_members_minus2 + | |
| 1; i++ ) | |
| nnpfgc_member_id[ i ] | ue(v) |
| nnpfgc_complexity_info_present_flag | u(1) |
| if( nnpfgc_complexity_info_present_flag ) { | |
| nnpfgc_parameter_type_idc | u(2) |
| if( nnpfgc_parameter_type_idc != 2 ) | |
| nnpfgc_log2_parameter_bit_length_minus3 | u(2) |
| nnpfgc_num_parameters_idc | u(6) |
| nnpfgc_num_kmac_operations_idc | ue(v) |
| nnpfgc_total_kilobyte_size | ue(v) |
| } | |
| } | |

### 8.28.4.2 Neural-Network Post-Filter Group Characteristics SEI Message Semantics

The neural-network post-filter group characteristics (NNPFGC) SEI message specifies a neural network post-filter (NNPF) group. It is indicated by the SEI message if the NNPF group defines an NNPF cascade or defines NNPFs or NNPF groups of NNPF cascades that are alternatives to each other. The use of NNPF groups of NNPF cascades for specific pictures is indicated with neural-network post-filter group activation (NNPFGA) SEI messages.

nnpfgc_id contains an identifying number that may be used to identify an NNPF group. The value of nnpfgc_id shall be in the range of 0 to 2³²-2, inclusive. Values of nnpfgc_id from 256 to 511, inclusive, and from 2³¹ to 2³²-2, inclusive, are reserved for future use by ITU-T|ISO/IEC. Decoders conforming to this edition of this document encountering an NNPFGC SEI message with nnpfgc_id in the range of 256 to 511, inclusive, or in the range of 2³¹ to 2³²-2, inclusive, shall ignore the SEI message. The value of nnpfgc_id shall not be equal to any nnpfc_id value of any NNPFC SEI message present in the same CLVS. When the value of nnpfgc_id of an NNPFGC SEI message nnpfgcSeiA is equal to the value of nnpfgc_id of another NNPFGC SEI message nnpfgcSeiB present in the same CLVS, nnpfgcSeiA and nnpfgcSeiB shall be identical.

nnpfgc_grouping_type equal to 0 indicates that this SEI message specifies a group of cascaded neural-network post-filters.

nnpfgc_grouping_type equal to 1 indicates that the NNPFs or NNPF groups identified by the nnpfgc_member_id[i] are alternatives to each other out of which the post-processor should select only one to be applied.

nnpfgc_grouping_type equal to 2 indicates that this SEI message specifies a group of NNPFs that are intended to be used jointly and are activated in an alternating manner so that at most one of these NNPFs is activate for any picture.

nnpfgc_grouping_type equal to 3 indicates that the NNPFs or NNPF groups identified by the nnpfgc_member_id[i] are intended to be used in parallel.

nnpfgc_grouping_type equal to 4 indicates that the NNPFs or NNPF groups identified by the nnpfgc_member_id[i] are optional, i.e., may or may not be applied by the post-processor.

The value of nnpfgc_grouping_type shall be in the range of 0 to 255, inclusive. Values of nnpfgc_grouping_type in the range of 5 to 255, inclusive, are reserved for future specification by ITU-T|ISO/IEC and shall not be present in bitstreams conforming to this edition of this document. Decoders conforming to this edition of this document shall ignore NNPFGC SEI messages with nnpfgc_grouping_type in the range of 5 to 255, inclusive.

nnpfgc_purpose has the semantics of nnpfc_purpose but with the exception that the semantics are specified for the NNPF group defined by this SEI message rather than the NNPF defined by an NNPFC SEI message.

nnpfgc_num_members_minus2 plus 2 indicates the number of NNPFs or NNPF groups in the NNPF group that this SEI message defines.

nnpfgc_member_id[i] indicates the i-th member in the NNPF group defined by this SEI message as follows:
If there is an NNPF with nnpfc_id equal to nnpfgc_member_id[i] defined in the CLVS, the i-th member in the NNPF group defined by this SEI message is an NNPF that has nnpfc_id equal to nnpfgc_member_id[i].
Otherwise (there is no NNPF with nnpfc_id equal to nnpfgc_member_id[i] defined in the CLVS), the i-th member in the NNPF group defined by this SEI message is an NNPF group with nnpfgc_id equal to nnpfgc_member_id[i].

When an nnpfgc_member_id[i] value references an nnpfgc_id value of an NNPFGC SEI message nnpfgcSei, it is a requirement of bitstream conformance that the NNPFGC SEI message nnpfgcSei shall have nnpfgc_grouping_type equal to 0. When nnpfgc_grouping_type is equal to 0 or 2, it is a requirement of bitstream conformance that there is an NNPF with nnpfc_id value equal to nnpfgc_member_id[i] defined in the CLVS. When nnpfgc_grouping_type is equal to 1, 3, or 4, it is a requirement of bitstream conformance that there is an NNPF with nnpfc_id value equal to nnpfgc_member_id[i] or an NNPF group with nnpfgc_id value equal to nnpfgc_member_id[i] defined in the CLVS.

When nnpfgc_grouping_type is equal to 0, the NNPFs with nnpfc_id equal to nnpfgc_member_id[i] are performed in cascade in increasing order of i, as activated by an NNPFGA SEI message with nnpfga_target_id equal to nnpfgc_id.

nnpfgc_complexity_info_present_flag, nnpfgc_parameter_type_idc, nnpfgc_log2_parameter_bit_length_minus3, nnpfgc_num_parameters_idc, nnpfgc_num_kmac_operations_idc, and nnpfgc_total_kilobyte_size have the semantics of nnpfc_complexity_info_present_flag, nnpfc_parameter_type_idc, nnpfc_log2_parameter_bit_length_minus3, nnpfc_num_parameters_idc, nnpfc_num_kmac_operations_idc, and nnpfc_total_kilobyte_size, respectively, but with the exception that the semantics are specified for the NNPF group defined by this SEI message rather than the NNPF defined by an NNPFC SEI message. When nnpfgc_grouping_type is equal to 1, nnpfgc_complexity_info_present_flag shall be equal to 0.

### 8.28.5 Neural-Network Post-Filter Group Activation SEI Message

### 8.28.5.1 Neural-Network Post-Filter Group Activation SEI Message Syntax

| | Descriptor |
|---|---|
| nn_post_filter_group_activation( payloadSize ) { | |
| nnpfga_target_id | ue(v) |
| nnpfga_cancel_flag | u(1) |
| if( !nnpfga_cancel_flag ) { | |
| nnpfga_persistence_flag | u(1) |
| nnpfga_num_filters_minus2 | ue(v) |
| for( i = 0; i <= nnpfga_num_filters_minus2 + 1; | |
| i++ ) { | |
| nnpfga_target_base_flag[ i ] | u(1) |
| nnpfga_input_all_pics_flag[ i ] | u(1) |
| if( !nnpfga_input_all_pics_flag[ i ] ) { | |
| nnpfga_num_input_pics_minus1[ i ] | ue(v) |
| for( j = 0; j <= | |
| nnpfga_num_input_pics_minus1[ i ]; j++ ) | |
| nnpfga_input_pic_skip_count[ i ][ j ] | ue(v) |
| } | |
| nnpfga_num_output_entries[ i ] | ue(v) |
| for( j = 0; j < | |
| nnpfga_num_output_entries[ i ]; j++ ) | |
| nnpfga_output_flag[ i ][ j ] | u(1) |
| } | |
| } | |
| } | |

### 8.28.5.2 Neural-Network Post-Filter Group Activation SEI Message Semantics

The neural-network post-filter group activation (NNPFGA) SEI message activates or de-activates the possible use of the target neural-network post-processing filter group (NNPFG) of NNPF groups, identified by nnpfga_target_id, for post-processing filtering of a set of pictures. nnpfgc_grouping_type for the identified NNPF group shall be equal to 0 (cascade) or 1 (alternatives). When nnpfgc_grouping_type is equal to 1, each member of the group shall have the same number of input pictures and NNPF output pictures. For a particular picture for which the NNPFG is activated, the target NNPFG is the NNPFG specified by the last NNPFGC SEI message with nnpfgc_id equal to nnpfga_target_id, that precedes the first VCL NAL unit of the current picture in decoding order and the NNPFs of the target NNPFG are defined by the NNPFC SEI messages that have nnpfc_id equal to any nnpfgc_member_id[i] value of the target NNPFG and are present in the current picture unit or precede the current picture in decoding order.

Use of this SEI message requires the definition of the following variables:
Input picture width and height in units of luma samples, denoted herein by InitCroppedWidth[idx] and InitCroppedHeight[idx], respectively, of the candidate input pictures with index idx in the range of 0 to numCandInputPics−1, inclusive, that may be used as input for the NNPFG.
Luma sample array InitCroppedYPic[idx] and chroma sample arrays InitCroppedCbPic[idx] and InitCroppedCrPic[idx], when present, of the candidate input pictures with index idx in the range of 0 to numCandInputPics−1, inclusive, that may be used as input for the NNPFG.
Bit depth BitDepthy for the luma sample array of the candidate input pictures.
Bit depth BitDepthc for the chroma sample arrays, if any, of the candidate input pictures.
A chroma format indicator, denoted herein by ChromaFormatIdc, as described in subclause 7.3.
When nnpfc_auxiliary_inp_idc is equal to 1, a filtering strength control value array StrengthControlVal[idx] that shall contain real numbers in the range of 0 to 1, inclusive, of the candidate input pictures with index idx in the range of 0 to numCandInputPics−1, inclusive.

Candidate input picture with index 0 corresponds to the picture for which the NNPFG is activated by this NNPFGA SEI message. Candidate input picture with index i in the range of 1 to numCandInputPics−1, inclusive, precedes the candidate input picture with index i−1 in output order. Let candInputPicList[0] be the list of candidate input pictures in inverse output order.

nnpfga_target_id indicates the target NNPFG, which is specified by the NNPFGC SEI message that pertains to the current picture and have nnpfgc_id equal to nnpfga_target_id.

The value of nnpfga_target_id shall be in the range of 0 to 2³²-2, inclusive.

An NNPFGA SEI message with a particular value of nnpfga_target_id shall not be present in a current PU unless there is an NNPFGC SEI message with nnpfgc_id equal to the particular value of nnpfga_target_id and nnpfgc_grouping_type equal to 0 present in the current PU or in a PU that precedes the current PU in decoding order within the current CLVS.

When a PU contains both an NNPFGC SEI message with a particular value of nnpfgc_id and an NNPFGA SEI message with nnpfga_target_id equal to the particular value of nnpfgc_id, the NNPFGC SEI message shall precede the NNPFGA SEI message in decoding order.

nnpfga_cancel_flag equal to 1 indicates that the persistence of the target NNPFG established by any previous NNPFGA SEI message with the same nnpfga_target_id as the current SEI message is cancelled, i.e., the target NNPFG is no longer used unless it is activated by another NNPFGA SEI message with the same nnpfga_target_id as the current SEI message and nnpfga_cancel_flag equal to 0. nnpfga_cancel_flag equal to 0 indicates that the target NNPFG is activated for use.

nnpfga_persistence_flag specifies the persistence of the target NNPFG for the current layer.

nnpfga_persistence_flag equal to 0 specifies that the target NNPFG may be used for post-processing filtering for the current picture only.

nnpfga_persistence_flag equal to 1 specifies that the target NNPFG may be used for post-processing filtering for the current picture and all subsequent pictures of the current layer in output order until one or more of the following conditions are true:
A new CLVS of the current layer begins.
The bitstream ends.
A picture in the current layer associated with an NNPFGA SEI message with the same nnpfga_target_id as the current SEI message that follows the current picture in output order.

NOTE—The target NNPFG is not applied for this subsequent picture in the current layer associated with an NNPFGA SEI message with the same nnpfga_target_id as the current SEI message.

Let the nnpfgcTargetPictures be the set of pictures to which the last NNPFGC SEI message with nnpfgc_id equal to nnpfga_target_id that precedes the current NNPFGA SEI message in decoding order pertains. Let nnpfgaTargetPictures be the set of pictures for which the target NNPFG is activated by the current NNPFGA SEI message. It is a requirement of bitstream conformance that any picture included in nnpfgaTargetPictures shall also be included in nnpfgcTargetPictures.

nnpfga_num_filters_minus2 plus 2 indicates the number of NNPFs in the NNPFG that this SEI message activates. The value of nnpfga_num_filters_minus2 shall be equal to the value of nnpfgc_num_members_minus2 in an NNPFGC SEI message with nnpfgc_id equal to nnpfga_target_id.

nnpfga_target_base_flag[i] equal to 1 specifies that the i-th NNPF in the target NNPFG is the base NNPF with nnpfc_id equal to nnpfgc_member_id[i] in an NNPFGC SEI message with nnpfgc_id equal to nnpfga_target_id. nnpfga_target_base_flag[i] equal to 0 specifies that the i-th NNPF in the target NNPFG is the NNPF specified by the last NNPFC SEI message that has nnpfc_id equal to nnpfgc_member_id[i] in an NNPFGC SEI message with nnpfgc_id equal to nnpfga_target_id, precedes the first VCL NAL unit of the current picture in decoding order, and is not a repetition of the NNPFC SEI message that contains the base NNPF.

nnpfga_input_all_pics_flag[i] equal to 1 specifies that the input pictures to the i-th NNPF are selected from the list of candidate input pictures candInputPicList[i] without skipping. nnpfga_input_all_pics_flag[i] equal to 0 specifies that the input pictures to the i-th NNPF are selected from the list of candidate input pictures candInputPicList[i] in a manner that some candidate input pictures are skipped.

nnpfga_num_input_pics_minus1[i] specifies the number of input pictures for the i-th NNPF in the target NNPFG. When present, nnpfga_num_input_pics_minus1[i] shall be equal to nnpfc_num_input_pics_minus1 for an NNPF with nnpfc_id equal to nnpfgc_member_id[i] of an NNPFGC SEI message with nnpfgc_id equal to nnpfga_target_id. When not present, nnpfga_num_input_pics_minus1[i] is inferred to be equal to nnpfc_num_input_pics_minus1 for an NNPF with nnpfc_id equal to nnpfgc_member_id[i] in an NNPFGC SEI message with nnpfgc_id equal to nnpfga_target_id.

nnpfga_input_pic_skip_count[i][j] specifies a j-th picture count that is skipped in the list of candidate input pictures candInputPicList[i] when selecting input pictures for the NNPF activated by the i-th loop entry. When nnpfga_input_pic_skip_count[i][j] is not present, it is inferred to be equal to 0 for all values of j in the range of 0 to nnpfga_num_input_pics_minus1 [i], inclusive. The variable numCandInputPics, which indicates the number of candidate input pictures to the NNPFG, is derived as follows:

$$numCandInputPics = 0$$

$$for ( j = 0 ; j <= nnpfga\_num \_input \_pics \_minus 1 [ 0 ] ; j ++ )$$

$$numCandInputPics += 1 + nnpfga\_input \_pic \_skip \_count [ 0 ] [ j ] ( xx )$$

Let candInputPicList[m] for m in the range of 1 to nnpfga_num_filters_minus2+1, inclusive, be a list of pictures in inverse output order that is initially empty and formed in decreasing order of n in the range of 0 to m−1, inclusive, by including each picture that is output by the NNPF process of the n-th loop entry that has no corresponding picture already present in candInputPicList[m], and lastly including each picture present in candInputPicList[0] that has no corresponding picture already present in candInputPicList[m].

When a candidate input picture candInputPicList[m][idx] for any value of m in the range of 1 to nnpfga_num_filters_minus2+1, inclusive, is an NNPF output picture of the n-th NNPF process with the value of n being less than the value of m, the width and height of the candidate input picture are respectively equal to nnpfcOutputPicWidth and nnpfcOutputPicHeight of the NNPF output picture.

The list of input pictures inputPicList[m] to the NNPF of the m-th loop entry is derived as follows:

$$for ( k = 0 , candIdx = 0 ; k <= nnpfga\_num \_input \_minus 1 [ m ] ;$$

$$k ++ , candIdx ++ ) \{$$

$$candIdx += nnpfga\_input \_pic \_skip \_count [ m ] [ k ]$$

$$inputPicList [ m ] [ k ] = candInputPicList [ m ] [ candIdx ] ( xx ) \}$$

It is a requirement of bitstream conformance that candIdx shall not exceed the number of pictures in candInputPicList[m].

It is a requirement of bitstream conformance that the pictures present in inputPicList[m], for any value of m in the range of 1 to nnpfga_num_filters_minus2+1, inclusive, shall have the same width, height, bit depth, and chroma format.

For purposes of interpretation of the NNPFC SEI message with nnpfc_id equal to nnpfgc_member_id[i] in an NNPFGC SEI message with nnpfgc_id equal to nnpfga_target_id, the following variables are specified for the i-th loop entry:
The variables BitDepth_{Y}, BitDepth_{C}, and ChromaFormatIdc are used as provided for the interpretation of this SEI message.
CroppedWidth and CroppedHeight are set equal to the width and height of the pictures in inputPicList[i], respectively, in units of luma samples.
For each input picture k in the range of 0 to nnpfga_num_input_pics_minus1 [i], inclusive, the following applies:
   CroppedYPic[k], CroppedCbPic[k], and CroppedCrPic[k], when present, are set equal to respective sample array of inputPicList[i][k]
   When nnpfc_auxiliary_inp_idc is equal to 1 for the NNPF with nnpfc_id equal to nnpfgc_member_id[i] in an NNPFGC SEI message with nnpfgc_id equal to nnpfga_target_id, the following applies:
It is a requirement of bitstream conformance that inputPicList[i][k] is the same as candInputPicList[0][idx] for any value of idx in the range of 0 to numCandInputPics−1, inclusive.
StrengthControlVal[k] is set equal to InitStrengthControlVal[idx]. nnpfga_num_output_entries[i] specifies the number of nnpfga_output_flag[i][j] syntax elements present in the NNPFGA SEI message. The value of nnpfga_num_output_entries[i] shall be in the range of 0 to NumInpPicsInOutputTensor, inclusive, for an NNPF with nnpfc_id equal to nnpfgc_member_id[i] of an NNPFGC SEI message with nnpfgc_id equal to nnpfga_target_id.

nnpfga_output_flag[i][j] equal to 1 specifies that the NNPF-generated picture that corresponds to the input picture having index InpIdx[j] derived for the i-th NNPF of the target NNPFG is output by the NNPF process activated by this loop entry, where the NNPF process is specified in the semantics of the NNPFC SEI message. nnpfga_output_flag[i][j] equal to 0 specifies that the NNPF-generated picture that corresponds to the input picture having index InpIdx[j] derived for the i-th NNPF of the target NNPFG is not output by the NNPF process activated by this loop less entry. When nnpfga_num_output_entries[i] is than NumInpPicsInOutputTensor derived for the i-th NNPF of the target NNPFG, nnpfga_output_flag[i][j] is inferred to be equal to 1 for each value of i in the range of nnpfga_num_output_entries[i] to NumInpPicsInOutputTensor−1, inclusive.

Let NnpfgaOutputPicList, which is the list of pictures output by NNPF process of the NNPFG in output order, be initially empty and formed in decreasing order of n in the range of 0 to nnpfga_num_filters_minus2+1, inclusive, by including each picture that is output by the NNPF process of the n-th loop entry that has no corresponding picture already present in NnpfgaOutputPicList.

### 4. Technical Problems Solved by Disclosed Embodiments

An example design for the neural-network post-filter SEI messages and their interface have the following problems:

First, the following syntax and semantics are specified on nnpfgc_purpose.

| | Descriptor |
|---|---|
| nn_post_filter_group_characteristics( payloadSize ) { | |
| nnpfgc_id | ue(v) |
| nnpfgc_grouping_type | ue(v) |
| if( nnpfgc_grouping_type = = 0 \|\| | |
| nnpfgc_grouping_type = = 2 ) | |
| nnpfgc_purpose | u(16) |
| ... | |
| } | |

nnpfgc_purpose has the semantics of nnpfc_purpose but with the exception that the semantics are specified for the NNPF group defined by this SEI message rather than the NNPF defined by an NNPFC SEI message.

However, when nnpfgc_grouping_type is equal to 0 (cascading), nnpfgc_purpose is signaled such that all NNPFs in this NNPF group characteristics (NNPFGC) are constrained with the same purpose. According to the original intent of NNPF design, multiple filters defined with individual purposes are allowed. When nnpfgc_grouping_type is equal to 0, nnpfgc_purpose should not be signaled.

In addition, when nnpfgc_grouping_type is equal to 1 (alternatives), every member NNPF (G) defined in the NNPFGC SEI message should be constrained with a same nnpfgc_purpose. Therefore, when nnpfgc_grouping_type is equal to 1, nnpfgc_purpose should be signaled.

Second, the following constraint is specified on the candIdx of candInputPicList[m]: It is a requirement of bitstream conformance that candIdx shall not exceed the number of pictures in candInputPicList[m].

However, when candIdx is equal to the number of pictures in candInputPicList[m], candIdx would be out of the index range of the candInputPicList[m]. Hence, candIdx should not exceed the number of pictures in candInputPicList[m] minus one.

Third, the following constraint is specified on nnpfgc_grouping_type: An NNPFGA SEI message with a particular value of nnpfga_target_id shall not be present in a current PU unless there is an NNPFGC SEI message with nnpfgc_id equal to the particular value of nnpfga_target_id and nnpfgc_grouping_type equal to 0 present in the current PU or in a PU that precedes the current PU in decoding order within the current CLVS.

In an example design of NNPFG, when nnpfgc_grouping_type defined in an NNPFGC SEI message is equal to 1 (alternatives), activating this NNPFG also needs an NNPFGA SEI message. However, the constraint here misses the case of nnpfgc_grouping_type equal to 1. This technique issue should be fixed and related text needs to be clarified.

Fourth, the following requirement is specified on the value of num_interpolated_pics[i−1]:

| | Descriptor |
|---|---|
| nn_post_filter_group_activation( payloadSize ) { | |
| nnpfga_target_id | ue(v) |
| nnpfga_cancel_flag | u(1) |
| if( !nnpfga_cancel_flag ) { | |
| nnpfga_persistence_flag | u(1) |
| nnpfga_num_filters_minus2 | ue(v) |
| for( i = 0; i <= nnpfga_num_filters_minus2 + | |
| 1; i++ ) { | |
| nnpfga_target_base_flag[ i ] | u(1) |
| nnpfga_input_all_pics_flag[ i ] | u(1) |
| if( !nnpfga_input_all_pics_flag[ i ] ) { | |
| nnpfga_num_input_pics_minus1[ i ] | ue(v) |
| for( j = 0; j <= | |
| nnpfga_num_input_pics_minus1[ i ]; j++ ) | |
| nnpfga_input_pic_skip_count[ i ][ j ] | ue(v) |
| } | |
| nnpfga_num_output_entries[ i ] | ue(v) |
| for( j = 0; j < nnpfga_num_output_entries[ i ]; | |
| j++ ) | |
| nnpfga_output_flag[ i ][ j ] | u(1) |
| } | |
| } | |
| } | |

nnpfga_num_output_entries[i] specifies the number of nnpfga_output_flag[i][j] syntax elements present in the NNPFGA SEI message. The value of nnpfga_num_output_entries[i] shall be in the range of 0 to NumInpPicsInOutputTensor, inclusive, for an NNPF with nnpfc_id equal to nnpfgc_member_id[i] of an NNPFGC SEI message with nnpfgc_id equal to nnpfga_target_id.

nnpfga_output_flag[i][j] equal to 1 specifies that the NNPF-generated picture that corresponds to the input picture having index InpIdx[j] derived for the i-th NNPF of the target NNPFG is output by the NNPF process activated by this loop entry, where the NNPF process is specified in the semantics of the NNPFC SEI message. nnpfga_output_flag[i][j] equal to 0 specifies that the NNPF-generated picture that corresponds to the input picture having index InpIdx[j] derived for the i-th NNPF of the target NNPFG is not output by the NNPF process activated by this loop entry. When nnpfga_num_output_entries[i] is less than NumInpPicsInOutputTensor derived for the i-th NNPF of the target NNPFG, nnpfga_output_flag[i][j] is inferred to be equal to 1 for each value of i in the range of nnpfga_num_output_entries[i] to NumInpPicsInOutputTensor-1, inclusive.

According to the constraints of NNPF, each activated member such as NNPF or NNPFG in an NNPFGA SEI message shall produce at least one output picture. However, in the example design, after an NNPFGA SEI message signals output pictures for each active member such as NNPF or NNPFG, any active member such as NNPF or NNPFG of this NNPFGA probably does not output any picture. This seems to be a bug and needs to be fixed.

### 5. a Listing of Solutions and Embodiments

To solve the above-described problems, methods as summarized below are disclosed. The aspects should be considered as examples to explain the general concepts and should not be interpreted in a narrow way. Furthermore, these examples can be applied individually or combined in any manner.

1) It is proposed that multiple NNPF (G) s defined in one SEI or in multiple SEIs may share the same NNPF purpose.
a. In one example, the shared NNPF purpose may be signaled in one SEI.
   i. In one example, it may be signaled in a conditional way.
b. In one example, to solve the first problem above, the syntax on the condition of signalling nnpfgc_purpose is modified such that when nnpfgc_grouping_type is equal to 1 (alternatives), all NNPF (G) members defined in the NNPFGC SEI message have a same nnpfgc_purpose.
   i. In one example, in the syntax on the condition of signalling nnpfgc_purpose, nnpfgc_purpose equal to 1 (alternatives) is inserted.

2) Alternatively, NNPFG(s) defined in one SEI may have different NNPF purposes.
a. In one example, the multiple NNPF purposes may be signaled in one SEI or in multiple SEIs.
   i. In one example, they may be signaled in a conditional way.
b. In one example, when nnpfgc_grouping_type is equal to 0 (cascading), all NNPF (G) members defined in the NNPFGC SEI message could have different nnpfc_purpose.
   i. In one example, in the syntax on the condition of signalling nnpfgc_purpose, nnpfgc_purpose equal to 0 (cascading) can be removed.

3) It is proposed that any member in a one-dimension container such as list, vector, or array, should not be out of the range.
a. In one example, to solve the second problem above, it is specified that, it is a requirement of bitstream conformance that candIdx shall not exceed the number of pictures in candInputPicList[m] minus 1.

4) It is proposed that when nnpfgc_grouping_type defined in an NNPFGC SEI message is equal to 1 (alternatives), activating this NNPFG needs an NNPFGA SEI message.
a. In one example, to solve the third problem above, nnpfgc_grouping_type equal to 1 is inserted into the following constraint:
   An NNPFGA SEI message with a particular value of nnpfga_target_id shall not be present in a current PU unless there is an NNPFGC SEI message with nnpfgc_id equal to the particular value of nnpfga_target_id and nnpfgc_grouping_type equal to 0 or 1 present in the current PU or in a PU that precedes the current PU in decoding order within the current CLVS.
b. In one example, in addition, to solve the third problem above, the clarification that the NNPFG with nnpfgc_grouping_type equal to 1 needs an NNPFGA SEI message to activate, is specified as follows:
   Otherwise (NnpfCand contains an NNPF group with nnpfgc_grouping_type equal to 1 and that NNPF group is activated for the current picture according to an NNPFGA SEI message), the following applies.

5) It is proposed that each activated member such as NNPF or NNPFG in an NNPFGA SEI message shall produce at least one output picture.
a. In one example, to solve the fourth problem above, the following constraint is specified: When PictureRateUpsamplingFlag from the i-th NNPF is equal to 0 and nnpfga_num_output_entries[i] is equal to NumInpPicsInOutputTensor derived from the i-th NNPF, nnpfga_output_flag[i][j] shall be equal to 1 for at least one value of j in the range of 0 to nnpfga_num_output_entries[i]−1, inclusive.

### 6. Embodiments

Below are some example embodiments for the aspects summarized above in Section 5.

Most relevant parts that have been added or modified are in “{{ }}”, and some of the deleted parts are in “/* * \”. There may be some other changes that are editorial in nature and thus not indicated.

### 6.1 Embodiment 1

This embodiment is for items 1 to 4 and all their subitems as summarized above in Section 5.

### 8.28.1.2 Filtering Process for One Picture

An NNPF or an NNPF group to be applied to the current picture is selected as follows:
If NnpfCand contains a single NNPF and that NNPF is activated for the current picture according to an NNPFA SEI message, that NNPF is selected to be applied to the current picture.
Otherwise, if NnpfCand contains an NNPF group with nnpfgc_grouping_type equal to 2 and any NNPF of the NNPF group is activated for the current picture according to NNPFA SEI message, that NNPF is selected to be applied to the current picture.
Otherwise, if NnpfCand contains an NNPF group with nnpfgc_grouping_type equal to 0 and that NNPF group is activated for the current picture according to an NNPFGA SEI message, that NNPF group is selected to be applied to the current picture.
Otherwise (NnpfCand contains an NNPF group with nnpfgc_grouping_type equal to 1 {{and that NNPF group is activated for the current picture according to an NNPFGA SEI message}}), the following applies:
   A set of candidate NNPFs or NNPF groups candSet is initially empty and then set to contain the following:
      The NNPFs that are activated for the current picture according to NNPFA SEI messages and are included in the NNPF group contained in NnpfCand.
      The NNPF groups that are activated for the current picture according to NNPFGA SEI messages and are included in the NNPF group contained in NnpfCand.
   For each candidate NNPF or NNPF group candFilter in candSet, the following applies:
      When one or more of the input pictures of candFilter are input pictures to the NNPF or NNPF group prevFilter that was used in any previous invocation of the filtering process specified in this subclause for the same NnpfCand, candFilter is excluded from candSet.
   Any NNPF or NNPF group remaining in candSet is selected to be applied to the current picture.

### 8.28.4 Neural-Network Post-Filter Group Characteristics SEI Message

### 8.28.4.1 Neural-Network Post-Filter Group Characteristics SEI Message Syntax

| | Descriptor |
|---|---|
| nn_post_filter_group_characteristics( payloadSize ) { | |
| nnpfgc_id | ue(v) |
| nnpfgc_grouping_type | ue(v) |
| if( nnpfgc_grouping_type = = /*0*\ {{1}} \|\| | |
| nnpfgc_grouping_type = = 2 ) | |
| nnpfgc_purpose | u(16) |
| nnpfgc_num_members_minus2 | ue(v) |
| for( i = 0; i <= nnpfgc_num_members_minus2 + 1; i++ ) | |
| nnpfgc_member_id[ i ] | ue(v) |
| nnpfgc_complexity_info_present_flag | u(1) |
| if( nnpfgc_complexity_info_present_flag ) { | |
| nnpfgc_parameter_type_idc | u(2) |
| if( nnpfgc_parameter_type_idc != 2 ) | |
| nnpfgc_log2_parameter_bit_length_minus3 | u(2) |
| nnpfgc_num_parameters_idc | u(6) |
| nnpfgc_num_kmac_operations_idc | ue(v) |
| nnpfgc_total_kilobyte_size | ue(v) |
| } | |
| } | |

### 8.28.5.2 Neural-Network Post-Filter Group Activation SEI Message Semantics

nnpfga_target_id indicates the target NNPFG, which is specified by the NNPFGC SEI message that pertains to the current picture and have nnpfgc_id equal to nnpfga_target_id.

The value of nnpfga_target_id shall be in the range of 0 to 2³²-2, inclusive.

An NNPFGA SEI message with a particular value of nnpfga_target_id shall not be present in a current PU unless there is an NNPFGC SEI message with nnpfgc_id equal to the particular value of nnpfga_target_id and nnpfgc_grouping_type equal to 0 {{or 1}} present in the current PU or in a PU that precedes the current PU in decoding order within the current CLVS.

The list of input pictures inputPicList[m] to the NNPF of the m-th loop entry is derived as follows:

$$for ( k = 0 , candIdx = 0 ; k <= nnpfga\_num \_input \_pics \_minus 1 [ m ] ;$$

$$k ++ , candIdx ++ ) \{$$

$$candIdx += nnpfga\_input \_pic \_skip \_count [ m ] [ k ]$$

$$inputPicList [ m ] [ k ] = candInputPicList [ m ] [ candIdx ] ( xx ) \}$$

It is a requirement of bitstream conformance that candIdx shall not exceed the number of pictures in candInputPicList[m] {{minus 1}}.

nnpfga_num_output_entries[i] specifies the number of nnpfga_output_flag[i][j] syntax elements present in the NNPFGA SEI message. The value of nnpfga_num_output_entries[i] shall be in the range of 0 to NumInpPicsInOutputTensor, inclusive, for an NNPF with nnpfc_id equal to nnpfgc_member_id[i] of an NNPFGC SEI message with nnpfgc_id equal to nnpfga_target_id.

{{When PictureRateUpsamplingFlag from the i-th NNPF is equal to 0 and nnpfga_num_output_entries[i] is equal to NumInpPicsInOutputTensor derived from the i-th NNPF, nnpfga_output_flag[i][j] shall be equal to 1 for at least one value of j in the range of 0 to nnpfga_num_output_entries[i]−1, inclusive.}}

nnpfga_output_flag[i][j] equal to 1 specifies that the NNPF-generated picture that corresponds to the input picture having index InpIdx[j] derived for the i-th NNPF of the target NNPFG is output by the NNPF process activated by this loop entry, where the NNPF process is specified in the semantics of the NNPFC SEI message. nnpfga_output_flag[i][j] equal to 0 specifies that the NNPF-generated picture that corresponds to the input picture having index InpIdx[j] derived for the i-th NNPF of the target NNPFG is not output by the NNPF process activated by this loop entry. When nnpfga_num_output_entries[i] is less than NumInpPicsInOutputTensor derived for the i-th NNPF of the target NNPFG, nnpfga_output_flag[i][j] is inferred to be equal to 1 for each value of i in the range of nnpfga_num_output_entries[i] to NumInpPicsInOutputTensor-1, inclusive.

### 7. References

[1] ITU-T and ISO/IEC, “High efficiency video coding”, Rec. ITU-T H.265|ISO/IEC 23008-2 (in force edition).
[2] J. Chen, E. Alshina, G. J. Sullivan, J.-R. Ohm, J. Boyce, “Algorithm description of Joint Exploration Test Model 7 (JEM7),” JVET-G1001, August 2017.
[3] Rec. ITU-T H.266|ISO/IEC 23090-3, “Versatile Video Coding”, 2022.
[4] Rec. ITU-T Rec. H.274|ISO/IEC 23002-7, “Versatile Supplemental Enhancement Information Messages for Coded Video Bitstreams”, 2022.
[5] S. McCarthy, T. Chujoh, M. Hannuksela, G. J. Sullivan, and Y.-K. Wang (editors), “Additional SEI messages for VSEI (Draft 5)”, JVET output document JVET-AE2006, publicly available online herein: https://jvet-experts.org/doc_end_user/current_document.php?id=13271.
[6] B. Bross, E. François, M. M. Hannuksela, A. Tourapis, and Y.-K. Wang (editors), “New level and systems-related supplemental enhancement information for VVC (Draft 6)”, JVET output document JVET-AE2005, publicly available online herein: https://jvet-experts.org/doc_end_user/current_document.php?id=13270.
[7] M. M. Hannuksela, J. Chen, S. Deshpande, S. McCarthy, “Technologies under consideration for future extensions of VSEI (draft 1)”, JVET output document JVET-AE2032, publicly available online herein: https://jvet-experts.org/doc_end_user/current_document.php?id=13282.

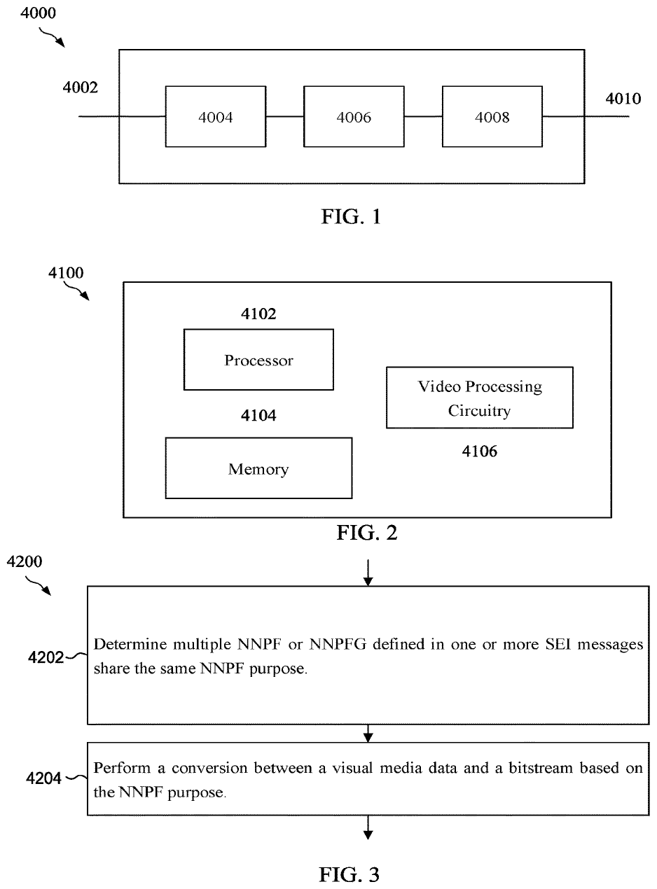

FIG. 1 is a block diagram showing an example video processing system 4000 in which various embodiments disclosed herein may be implemented. Various implementations may include some or all of the components of the system 4000. The system 4000 may include input 4002 for receiving video content. The video content may be received in a raw or uncompressed format, e.g., 8- or 10-bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or DisplayPort, and so on. Examples of storage interfaces include serial advanced technology attachment (SATA), peripheral component interconnect (PCI), integrated drive electronics (IDE) interface, and the like. The embodiments described in the present disclosure may be embodied in various electronic devices such as mobile phones, laptops, smartphones or other devices that are capable of performing digital data processing and/or video display.

FIG. 2 is a block diagram of an example video processing apparatus 4100. The apparatus 4100 may be used to implement one or more of the methods described herein. The apparatus 4100 may be embodied in a smartphone, tablet, computer, Internet of Things (IOT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and embodiments described herein. The video processing circuitry 4106 may be used to implement, in hardware circuitry, some embodiments described in the present disclosure. In some embodiments, the video processing circuitry 4106 may be at least partly included in the processor 4102, e.g., a graphics co-processor.

FIG. 3 is a flowchart for an example method 4200 of video processing. The method 4200 determines multiple neural-network post-filters (NNPF) or neural-network post-processing filter group (NNPFG) defined in one or more supplemental enhancement information (SEI) messages share the same NNPF purpose at step 4202. A conversion between a visual media data and a bitstream is performed based on the NNPF purpose at step 4204. The conversion may include encoding at an encoder, decoding at a decoder, or combinations thereof.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

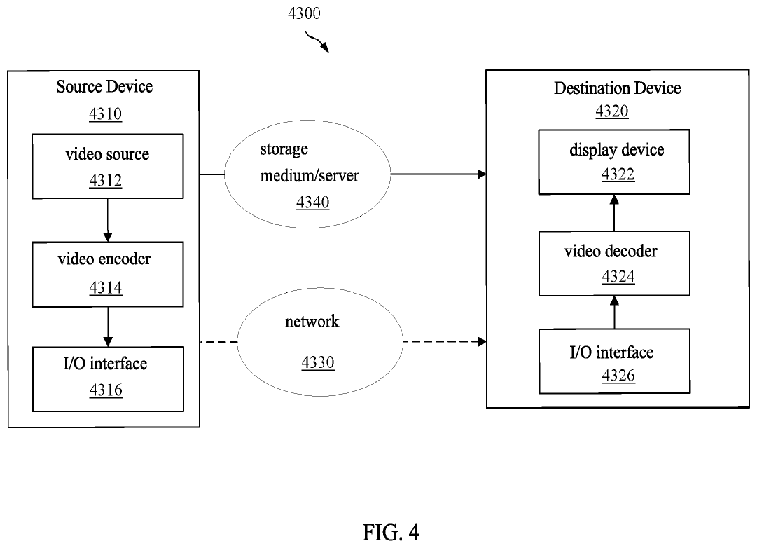

FIG. 4 is a block diagram that illustrates an example video coding system 4300 that may utilize the embodiments of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard and other current and/or further standards.

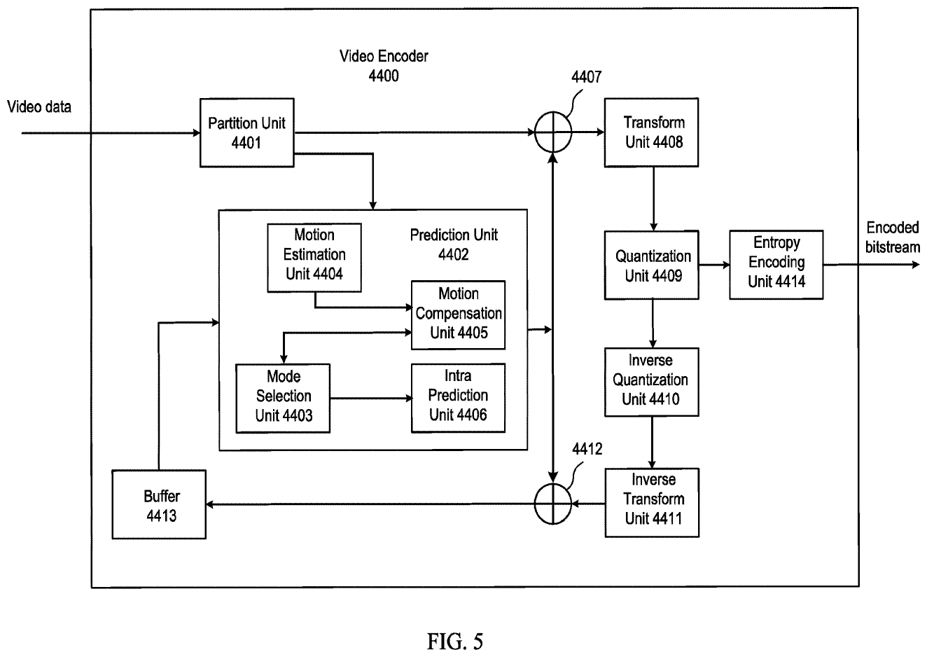

FIG. 5 is a block diagram illustrating an example of video encoder 4400, which may be video encoder 4314 in the system 4300 illustrated in FIG. 4. Video encoder 4400 may be configured to perform any or all of the embodiments of this disclosure. The video encoder 4400 includes a plurality of functional components. The embodiments described in this disclosure may be shared among the various components of video encoder 4400. In some examples, a processor may be configured to perform any or all of the embodiments described in this disclosure.

The functional components of video encoder 4400 may include a partition unit 4401; a prediction unit 4402, which may include a mode select unit 4403, a motion estimation unit 4404, a motion compensation unit 4405, and an intra prediction unit 4406; a residual generation unit 4407; a transform processing unit 4408; a quantization unit 4409; an inverse quantization unit 4410; an inverse transform unit 4411; a reconstruction unit 4412; a buffer 4413; and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

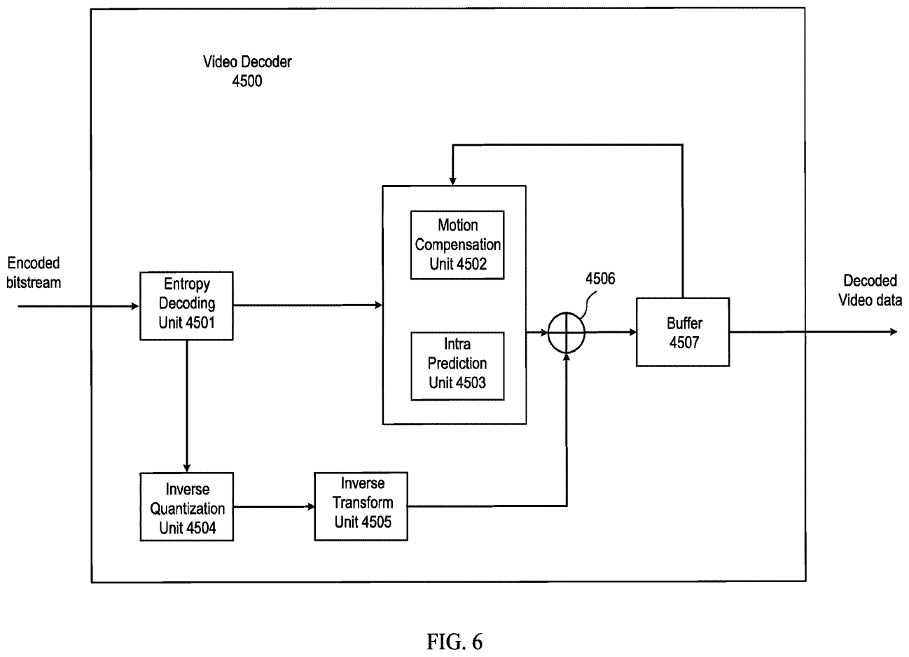

FIG. 6 is a block diagram illustrating an example of video decoder 4500 which may be video decoder 4324 in the system 4300 illustrated in FIG. 4. The video decoder 4500 may be configured to perform any or all of the embodiments of this disclosure. In the example shown, the video decoder 4500 includes a plurality of functional components. The embodiments described in this disclosure may be shared among the various components of the video decoder 4500. In some examples, a processor may be configured to perform any or all of the embodiments described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

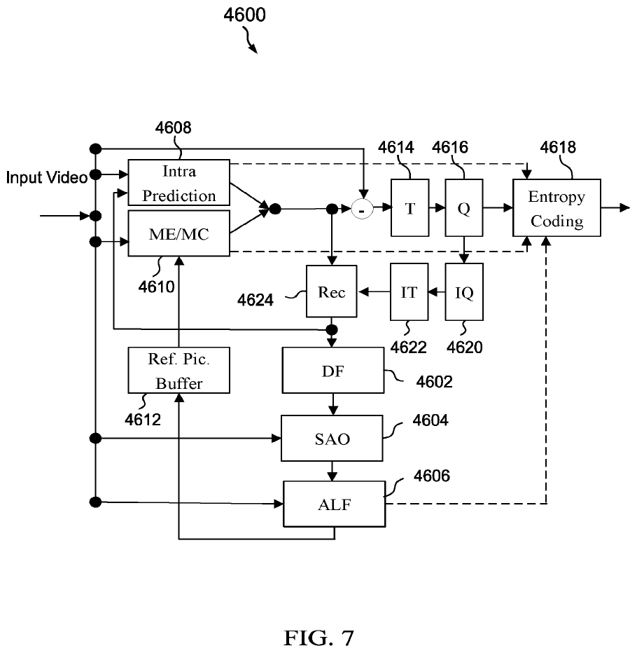

FIG. 7 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.

The following solutions show examples of embodiments discussed herein.

1. A method for processing media data comprising: determining multiple neural-network post-filters (NNPF) or neural-network post-processing filter group (NNPFG) defined in one or more supplemental enhancement information (SEI) messages share the same NNPF purpose; and performing a conversion between a visual media data and a bitstream based on the NNPF purpose.

2. The method of solution 1, wherein the shared NNPF purpose is signaled in one SEI message, or wherein the shared NNPF purpose is signaled conditionally.

3. The method of any of solutions 1-2, wherein when nnpfgc_grouping_type is equal to 1, all NNPF or NNPFG members defined in the neural-network post-filter group characteristics (NNPFGC) SEI message have a same nnpfgc_purpose, or wherein when signalling nnpfgc_purpose, nnpfgc_purpose equal to 1 is inserted.

4. The method of any of solutions 1-3, wherein NNPFGs defined in one SEI have different NNPF purposes.

5. The method of any of solutions 1-4, wherein multiple NNPF purposes are signaled in one or more SEIs or wherein the multiple NNPF purposes are signaled conditionally.

6. The method of any of solutions 1-5, wherein when nnpfgc_grouping_type is equal to 0, all NNPF or NNPFG members defined in the NNPFGC SEI message are allowed to have a different nnpfc_purpose, or wherein when signalling nnpfgc_purpose, nnpfgc_purpose equal to 0 is removed.

7. The method of any of solutions 1-6, wherein any member in a one-dimension container including list, vector, and array, should not be out of range, or wherein bitstream conformance requires that candIdx shall not exceed a number of pictures in candInputPicList[m] minus 1.

8. The method of any of solutions 1-7, wherein when nnpfgc_grouping_type defined in an NNPFGC SEI message is equal to 1, an NNPFGA SEI message is used to activate a corresponding NNPFG.

9. The method of any of solutions 1-8, wherein an NNPFGA SEI message with a particular value of nnpfga_target_id shall not be present in a current prediction unit (PU) unless there is an NNPFGC SEI message with nnpfgc_id equal to the particular value of nnpfga_target_id and nnpfgc_grouping_type equal to 0 or 1 present in the current PU or in a PU that precedes the current PU in decoding order within the current coded layer video sequence (CLVS).

10. The method of any of solutions 1-9, wherein when NnpfCand contains an NNPF group with nnpfgc_grouping_type equal to 1 and that NNPF group is activated for the current picture according to an NNPFGA SEI message, the following applies: a set of candidate NNPFs or NNPF groups candSet is initially empty and then set to contain the following: (1) the NNPFs that are activated for the current picture according to NNPFA SEI messages and are included in the NNPF group contained in NnpfCand; and (2) the NNPF groups that are activated for the current picture according to NNPFGA SEI messages and are included in the NNPF group contained in NnpfCand; for each candidate NNPF or NNPF group candFilter in candSet, the following applies: when one or more of the input pictures of candFilter are input pictures to the NNPF or NNPF group prevFilter that was used in any previous invocation of the filtering process specified in this subclause for the same NnpfCand, candFilter is excluded from candSet; and any NNPF or NNPF group remaining in candSet is selected to be applied to the current picture.

11. The method of any of solutions 1-10, wherein each activated member including an NNPF or an NNPFG in an NNPFGA SEI message shall produce at least one output picture.

12. The method of any of solutions 1-11, wherein when PictureRateUpsamplingFlag from the i-th NNPF is equal to 0 and nnpfga_num_output_entries[i] is equal to NumInpPicsInOutputTensor derived from the i-th NNPF, nnpfga_output_flag[i][j] shall be equal to 1 for at least one value of j in the range of 0 to nnpfga_num_output_entries[i]−1, inclusive.

13. An apparatus for processing video data comprising: a processor; and a non-transitory memory with instructions thereon, wherein the instructions upon execution by the processor, cause the processor to perform the method of any of solutions 1-12.

14. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-12.

15. A non-transitory computer-readable recording medium storing a bitstream of a video which is generated by a method performed by a video processing apparatus, wherein the method comprises: determining multiple neural-network post-filters (NNPF) or neural-network post-processing filter group (NNPFG) defined in one or more supplemental enhancement information (SEI) messages share the same NNPF purpose; and generating a bitstream based on the determining.

16. A method for storing bitstream of a video comprising: determining multiple neural-network post-filters (NNPF) or neural-network post-processing filter group (NNPFG) defined in one or more supplemental enhancement information (SEI) messages share the same NNPF purpose; generating a bitstream based on the determining; and storing the bitstream in a non-transitory computer-readable recording medium.

17. A method, apparatus, or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field-programmable gate array (FPGA) or an application-specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of the present disclosure. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, embodiments, systems, subsystems, and methods described and illustrated in the various embodiments as discrete or separate may be combined or integrated with other systems, modules, embodiments, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing media data, comprising:
determining that multiple neural-network post-processing filters (NNPFs) or neural-network post-processing filter groups (NNPFGs) defined in one or more supplemental enhancement information (SEI) messages share a same NNPF purpose; and
performing a conversion between visual media data and a bitstream based on the determining.

2. The method of claim 1, wherein a shared NNPF purpose is included in one SEI message.

3. The method of claim 2, wherein the shared NNPF purpose is included in the SEI message in a conditional way.

4. The method of claim 1, wherein in a case that nnpfgc_purpose is included in the bitstream, all NNPFs or NNPFGs defined in a neural-network post-filter group characteristics (NNPFGC) SEI message have a same nnpfgc_purpose when nnpfgc_grouping_type is equal to 1.

5. The method of claim 1, wherein in a case that nnpfgc_purpose is included in the bitstream, the nnpfgc_purpose equal to 1 is inserted.

6. The method of claim 1, wherein NNPFGs defined in one SEI message have different NNPF purposes.

7. The method of claim 1, wherein multiple NNPF purposes are included in one or more SEI messages, or wherein the multiple NNPF purposes are included in the one or more SEI messages conditionally.

8. The method of claim 1, wherein all NNPFs or NNPFGs defined in an NNPFGC SEI message are allowed to have different nnpfc_purpose when nnpfgc_grouping_type is equal to 0.

9. The method of claim 1, wherein in a case that nnpfgc_purpose is included in the bitstream, nnpfgc_purpose equal to 0 is removed.

10. The method of claim 1, wherein any member in a one-dimensional container is within a range, wherein bitstream conformance requires that a member being within the range comprises the member having an associated candIdx that does not exceed a number of pictures in candInputPicList[m] minus 1.

11. The method of claim 10, wherein the one-dimensional container includes a list, a vector, or an array.

12. The method of claim 1, wherein when nnpfgc_grouping_type defined in an NNPFGC SEI message is equal to 1, a neural-network post-filter group activation (NNPFGA) SEI message is used to activate a corresponding NNPFG.

13. The method of claim 1, wherein an NNPFGA SEI message with a particular value of nnpfga_target_id is not present in a current prediction unit (PU) unless there is an NNPFGC SEI message with nnpfgc_id equal to the particular value of nnpfga_target_id and nnpfgc_grouping_type equal to 1 present in the current PU or in a PU that precedes the current PU in a decoding order within a current coded layer video sequence (CLVS).

14. The method of claim 1, wherein when NnpfCand contains an NNPF group with nnpfgc_grouping_type equal to 1 and the NNPF group is activated for a current picture according to an NNPFGA SEI message, the following applies:
a set of candidate NNPFs or NNPF groups candSet is initially empty and then set to contain the following: (1) the NNPFs that are activated for the current picture according to neural-network post-filter activation (NNPFA) SEI messages and are included in the NNPF group contained in NnpfCand; and (2) the NNPF groups that are activated for the current picture according to NNPFGA SEI messages and are included in the NNPF group contained in NnpfCand,
wherein for each candidate NNPF or NNPF group candFilter in candSet, when one or more input pictures of candFilter are input pictures to the NNPF or NNPF group prevFilter that was used in any previous invocation of a filtering process for a same NnpfCand, candFilter is excluded from candSet, and
wherein any NNPF or NNPF group remaining in candSet is selected to be applied to the current picture.

15. The method of claim 1, wherein each activated member including an NNPF or an NNPFG in an NNPFGA SEI message produces at least one output picture.

16. The method of claim 1, wherein when PictureRateUpsamplingFlag from an i-th NNPF is equal to 0 and nnpfga_num_output_entries[i] is equal to NumInpPicsInOutputTensor derived from the i-th NNPF, nnpfga_output_flag[i][j] is equal to 1 for at least one value of j in a range of 0 to nnpfga_num_output_entries[i]−1, inclusive.

17. The method of claim 1, wherein the conversion includes encoding the visual media data into the bitstream.

18. The method of claim 1, wherein the conversion includes decoding the visual media data from the bitstream.

19. An apparatus for processing video data comprising a processor and a non-transitory memory with instructions thereon, wherein the instructions upon execution by the processor, cause the processor to:
determine that multiple neural-network post-processing filters (NNPFs) or neural-network post-processing filter groups (NNPFGs) defined in one or more supplemental enhancement information (SEI) messages share a same NNPF purpose; and
perform a conversion between visual media data and a bitstream based on the determining.

20. A non-transitory computer-readable recording medium storing a bitstream of a video which is generated by a method performed by a video processing apparatus, wherein the method comprises:
determining that multiple neural-network post-processing filters (NNPFs) or neural-network post-processing filter groups (NNPFGs) defined in one or more supplemental enhancement information (SEI) messages share a same NNPF purpose; and
generating the bitstream based on the determining.
